(19) United States
(12) Patent Application Publication
(10) Pub. No.: US 2004/0196461 A1
(43) Pub. Date: Oct. 7, 2004

(54) Process advancement in color management

(75) Inventors: Niraj Agarwal, Charlotte, NC (US); Douglas A. Bynum, Mooresville, NC (US); William T. Sherrill, Charlotte, NC (US)

Correspondence Address: CLARIANT CORPORATION, Industrial Property Department, 4000 Monroe Road, Charlotte, NC, 28205, US

(73) Assignee: Clariant International Ltd.

(21) Appl. No.: 10/406,924

(22) Filed: Apr. 4, 2003

(51) Int. Cl. G01J 3/46

(52) U.S. Cl. 356/402

(57) ABSTRACT

The present invention is directed to a method of managing color. A submission created by a product vendor is received. The submission is analyzed by a third party by, at least, electronic means. The analysis of the submission by the third party is communicated to a retailer.

### FIELD OF THE INVENTION

This invention is directed to a process for color management in manufactured goods.

### BACKGROUND OF THE INVENTION

Color management in the manufacture of goods is an important aspect in the successful marketing and sale of most, if not all, retail goods. The management of color is becoming more complex. Not only does one have to manage the color of the article for acceptable shade, properties, and performance, but also one may have to consider multiple substrates sourced from various manufacturers or vendors. Some aspects of the complexities associated with color management are discussed, in part, in related U.S. patent application Ser. No. 09/883,647 filed Jun. 18, 2001; Ser. No. 10/109,122 filed Mar. 28, 2002; and Ser. No. 10/195,251 filed Jul. 15, 2002, each is incorporated herein by reference.

U.S. application Ser. No. 09/883,647 discloses a method for improving communication between a retailer and a product vendor. This communication process revolves around the use of an ECS (engineered color standard). The ECS contains information about the desired color, such as reflectance data and a dye specification. The purpose behind the ECS is to provide a reliable, realistic, and readily matchable color standard, and thereby improve the management of color.

U.S. application Ser. No. 10/109,122 discloses a color matching system. The color matching system utilizes a database of information describing colorants to match a desired color to a known colorant(s) or colorant recipe(s) from the database. The purpose behind the color matching system is to reduce subjectivity in the color matching process, and thereby improves the management of color.

U.S. patent application Ser. No. 10/195,251 discloses a method for approving a color. In this process, it is contemplated that the product vendor and retailer have complimentary equipment and software. These complimentary features are intended to improve communication between the product vendor and the retailer, and thereby reduce subjectivity in the approval process, which, in turn, should speed up approvals.

While the foregoing applications describe processes that have greatly improved color management, as evidenced from the growing commercial use of those processes, there is still room for further improvement. For example, lag time still exists in the approval process. After a product vendor is selected by the retailer, but before production of the article desired by the retailer, there is an approval step. During this step, the product vendor sets up their manufacturing process to mass-produce the article. During the setup, the product vendor consults with the retailer on all aspects of the production of the article, including color, to insure that the mass-produced article is the article that the retailer envisions. This consulting can involve several iterations between product vendor and the retailer before finalization of the production process. In textile manufacture, where the retailer is usually located in one country and the product vendor in another country, perhaps half a world away, these consulting iterations may consume between 25-50 days. In automotive manufacture, where the distances between the retailer and product vendor may not be as great but the variety of materials within the automobile are several, there may be 6 rejections to 1 approval for the color submission process. Review and decision can be time consuming.

Referring to FIG. 1, in the past, communication 10 between the product vendor 12 and retailer (or brand owner) 14 was accomplished by physical means, e.g., post or courier. In this situation, the product vendor produced a sample for approval. That sample was then physically delivered to the retailer for approval. The retailer reviewed the sample, including color, usually by referral to a color professional, and then, rejected, approved, and/or commented on the sample. This feedback was returned to the product vendor. The feedback communication could be accomplished by post, courier, or electronically (telephone, facsimile, Internet). In FIG. 2, communication 20 between the product vendor 22 and retailer 24 improved via electronic means. The sample for approval is electronically analyzed by the product vendor 22. The equipment and software suitable for that analysis is set forth in U.S. application Ser. No. 10/109,122. The electronic analysis produced by the product vendor 22 could then be electronically transmitted to the retailer 24 as proposed in U.S. application Ser. No. 10/195,251. Conceptually, this process is sound; practically, however, implementation of this process has been difficult. The source of this difficulty arises from, at least, two areas. First, as mentioned at paragraph [0054] of U.S. application Ser. No. 10/195,251, the trust needed by the retailer in the product vendor's ability to produce true and repeatable analysis of the sample will build slowly, at best. The possible questions in the retailer's mind may include: will the product vendor invest and maintain the equipment and software necessary to perform reliable analysis; will the product vendor employ and train a qualified technician to perform the analysis; and will the product vendor commit the resources, capital, manpower, and time, to create a reliable analysis process. Second, the process set out in U.S. application Ser. No. 10/195,251 assumes that the product vendor will commit the resources, capital, manpower, and time, to create a reliable analysis process. Product vendors, however, have been reluctant to make that commitment. The possible questions in the product vendor's minds may include: if the commitment is made, will the retailer, in return, commit to purchase for a sufficient period so that the investment may be recouped; what if the individual trained leaves. In summary, real questions persist that could work against the rapid creation of trust that would make the process set out in U.S. application Ser. No. 10/195,251 meet expectations.

Accordingly, there is a need to improve the color management process lag time in the approval process, so that turnaround time is reduced.

### SUMMARY OF THE INVENTION

The present invention is directed to a method of managing color. A submission created by a product vendor is received. The submission is analyzed by a third party by, at least, electronic means. The third party's analysis of the submission is communicated to a retailer.

### DESCRIPTION OF THE DRAWINGS

For the purpose of illustrating the invention, there is shown in the drawings a form which is presently preferred; it being understood, however, that this invention is not limited to the process arrangements and instrumentalities shown.

FIG. 1 is a schematic representation of a prior art process for color management.

FIG. 2 is a schematic representation of a prior art process for color management.

FIG. 3 is a schematic representation of the present invention.

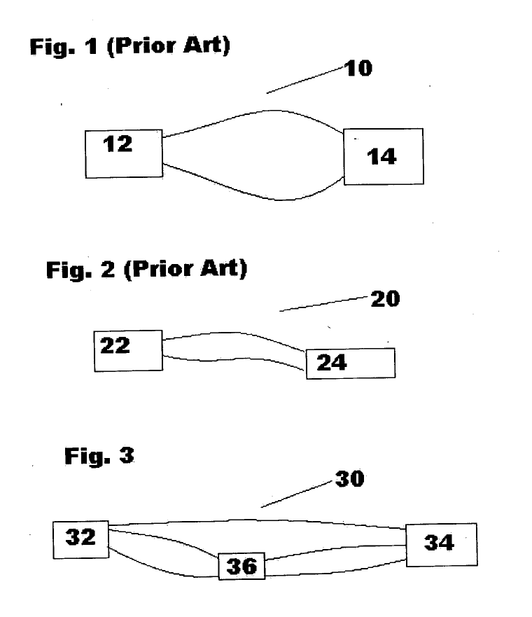

### DESCRIPTION OF THE INVENTION

Referring to the drawings, wherein like numerals indicate like elements, there is shown in FIG. 3 a schematic illustration of the instant invention 30. A product vendor 32 has produced a sample (submission) for approval by a retailer 34. The product vendor 32 is in a first location and the retailer 34 is in a second location. The first location and the second location are separated by, for example, a great distance. Such a great distance includes one country to another, for example, between the U.S. or Germany and Honduras or Pakistan, or Nigeria, or Uruguay, or Viet Nam. Retailer 34 has engaged a third party 36.

Third party 36 is preferably an independent contractor that is an entity independent of either product vendor 32 or retailer 34. Moreover, the third party 36 is located close to the product vendor 32. Close to the product vendor refers to a distance that may be, for example, easily traveled during a day. Third party 36, who will be discussed in greater detail below, has the capability of analyzing the sample produced by product vendor 32, at least from a color perspective, and communicating that analysis to the retailer 34. The third party 36 thereby serves several functions, such as, but not limited to, eliminating any trust issue around the analysis of the sample between the product vendor 32 and retailer 34, reducing the retailer's risk of variation in analysis by the product vendor, reducing the product vendor's investment exposure if the retailer does not sustain its relationship with the product vendor; and reducing lag time in the approval step by expediting analysis and communication.

The instant invention will be described in further detail below. For simplicities sake, the invention will be described with regard to textile garment production. It being understood, however, that the invention is not so limited. For example, a retailer refers to one who directly sells to consumers (e.g., a chain store: Target, Wal-Mart, K-Mart, Sears, Old Navy, GAP; or an automobile manufacturer: Ford, GMC, Daimler Chrysler), or one who sells coordinated products to a direct seller to consumers (e.g., clothing or house wares designers: Laura Ashley, Martha Stewart, or the like), or one who produces branded products (e.g., Marlboro, Nestles, Adidas, DKNY), or anyone who could take advantage of the present invention.

The product vendor 32, in Central America, produces a sample for approval by the retailer 34, in North America or Europe. The product vendor 32 delivers the sample, hereinafter a submission, to the third party 36, in Central America. Delivery refers to a physical delivery, such as via courier, to the third party 36, but also includes delivery where the third party 36 picks up the submission from product vendor 32. In the latter situation, the third party 36 may use a courier or a mobile or portable laboratory for on-site analysis.

Once the third party 36 has received the submission, they make ready to analyze the submission. Analyzing the submission preferably includes: providing the minimum requisite equipment and software, and a qualified technician; spectromapping the equipment; calibrating the equipment; preconditioning the submission; presenting the submission for spectral measurement; spectrally measuring the submission; and collecting the data from the spectral measurement. Additionally, but not necessarily, analyzing may further include: comparing the data from the spectral measurement to a specification; making an acceptance/rejection decision based upon the comparison; and commenting on the decision. Also, but not necessarily, analyzing while primarily focused on analysis facilitated by or involving electronic apparatus, may also encompass non-electronic analysis, such as visual and/or physical inspections by the third party. Visual inspection includes, for example, for surface-effect fabrics, such as stonewashed denims, or for pile fabrics, such as fleece or corduroy, some agreed-upon and acceptable visual methods. It being recognized that there are weaknesses in electronic means of inspection that can only be overcome via visual inspection. Physical inspection includes, for example, the tactile qualities (hand) of a fabric.

After analyzing, the analysis is communicated to the retailer 34. Communication is via an electronic means, preferably via the Internet (i.e., between computers). The analysis, which is in electronic form (e.g., digitally stored data of the results of the spectral measurement and any comments of the software or the qualified technician performing the analysis), is used by the retailer 34 to make approvals/rejections. Those approvals/rejections are then communicated back to the product vendor 32 either directly or through the third party 36, preferably via an electronic means (e.g., telephone, facsimile, or Internet, preferably via Internet). Depending on whether an approval/rejection is made, the process is repeated (reiterated) until finalization.

The minimum requisite equipment is a spectrophotometer coupled to a computer having color identifying measurement (or imaging) software. Further, the equipment may include a light box equipped with various standard light sources, temperature control, and humidity control, submission holders, a set of standard references with known spectral measurements, and a connection to the Internet. This equipment is conventional. For example, spectrophotometers and light boxes are available from Minolta Corporation USA, Ramsey, N.J.; Datacolor Corporation, Lawrenceville, N.J.; and Gretag-MacBeth, New Windsor, N.Y. Conditioning chambers are available from Vindon Scientific Ltd., Diggle, UK; and Raitech, Inc., Charlotte, N.C. Standard references (ceramic tiles) are available from Ceram Research Ltd., Penkhull, UK.

The qualified technician is an individual with a minimal amount of training in color analysis (both electronic and visual) and other fabric analysis (e.g., tactile qualities), manufacturing aspects of the use of color, submission handling, and operation of the equipment and software.

Spectromapping the equipment refers to establishing a measurement relationship between two spectrophotometers (and their software). Two identical spectrophotometers, when making spectral measurements of a sample, will not report identical measurements. These variations are typically within a given tolerance, but these variations are a source of distrust because those variations can lead to errors in the approval/rejection process. Spectromapping is performed initially and periodically thereafter, but not each time the instrument spectrally measures a sample. Spectromapping is intended to insure that true color measurements are reported (i.e., true, in the sense, to a reference instrument). For example, the third party 36 establishes a primary spectrophotometer. The primary spectrophotometer is the instrument by which all subsequent instruments are judged (i.e., the reference instrument). The primary spectrophotometer spectrally measures a reference standard at equilibrium. The measurement data is stored for future reference. Storage here refers to electronic storage, preferably digital storage of the data. A subsequent spectrophotometer, then, spectrally measures the reference standard at equilibrium. That measurement data is stored. The measurement data from the primary spectrophotometer is compared to the measurement data from the subsequent spectrophotometer. This comparison is preferably performed electronically via computer software. One software product capable of such comparison is MATCHWIZARD COMMUNICATOR™ from Clariant Corporation, Charlotte, N.C. The comparison generates an analysis that sets out the differences between the two measurements of the reference standard. This analysis forms the basis of the relationship between the primary and subsequent spectrophotometers. This relationship, in essence, a mathematical formulation, equates, within a predetermined tolerance, the measurements of the primary and the subsequent spectrophotometers. This relationship is the spectromap between the two spectrophotometers. Of course, it is understood that multiple spectral measurements are made by each spectrophotometer during the foregoing process and that averaging or other techniques may be used to arrive at a composite measurement representative of a given spectrophotometer. The spectromap is thereafter used by the subsequent spectrophotometer to adjust its spectral measurement, so that it corresponds to the primary spectrophotometer and reports spectral measurements, as would the primary spectrophotometer.

Calibrating the equipment is for insuring the equipment and software measure the submission in a known way. During calibration, the equipment and software may be adjusted to report measurements more closely to the reference, or the deviations may be recorded so that later measurements are properly interpreted. Calibrating includes: providing a standard reference having a known measurement; spectrally measuring the standard reference in the spectrophotometer coupled to the computer having the color identifying software; comparing the measurement of the standard reference to the known measurement of the standard reference; and adjusting, if necessary (determined by comparison to permissible tolerance values), the spectrophotometer coupled to the computer having the color identifying software.

Preconditioning the submission refers to allowing the submission to equilibrate to certain standard conditions that may have impact upon the measurement resulting from spectral measurement. Those conditions include, for example, light, temperature, and humidity.

Presenting the submission for spectral measurement refers to aligning the submission in a particular orientation. As is known, the angle at which the light reflects from the submission can have a material impact upon the resulting spectral measurement. Additionally, the orientation of the submission, e.g., in the machine direction or in the cross machine direction, may also have a material impact upon the resulting spectral measurement. Most preferably, the submission is presented on the front and the back at an orientation of 0° (first position) and 90° (second position).

Spectrally measuring (also known as spectral reflectance measuring or spectral imaging measuring) the submission refers to measuring the submission using the spectrophotometer coupled to the computer having the color identifying software. This measuring means collecting reflectance data. Preferably, during spectral measuring, sampling is taking a sufficient number of times to insure uniformity of the spectral measurement. Data is preferably recorded (collected) in an electronic form suitable for electronic transmission.

Data obtained from the spectral measurement of the submission may be compared to data from a specification provided by the retailer. The comparison of data determines whether the data from the submission is within the allowable tolerances of the retailer. These tolerances may be provided by the retailer or may be established by collaboration of the retailer and the third party. If within the tolerance, the submission is acceptable: and if without, rejected. Based upon the comparison, the third party 36, for example, may be able to make acceptance/rejection decision or at least screening recommendations based upon the comparison. Further, the third party 36 may be able to recommend possible solutions (commenting) in the event the submission is outside the acceptance criteria of the retailer 34. If the third party 36 does not make the acceptance/rejection decision, or a pre-evaluation, then that responsibility remains with the retailer 34. Then, retailer 34 uses that data to make its acceptance/rejection decision. That decision is then communicated, directly or indirectly, back to the product vendor 32.

The present invention may be embodied in other specific forms without departing from the spirit or essential attributes thereof, and, accordingly, reference should be made to the appended claims, rather than the foregoing specification, as indicating the scope of the invention.

1. A method of managing color comprises the steps of:
receiving a submission from a manufacturer;
analyzing the submission by a third party by, at least, electronic means; and
communicating the analysis of said third party to a retailer.

2. The method of claim 1 wherein electronically analyzing being accomplished via a spectrophotometer coupled to a computer having color identifying software.

3. The method of claim 2 wherein analyzing further comprises:
preconditioning the submission; and
spectrally measuring the submission.

4. The method of claim 3 wherein electronically analyzing further comprises:
presenting the submission for spectral measuring.

5. The method of claim 3 wherein preconditioning the submission further comprises:
allowing the submission to come to equilibrium under standard conditions.

6. The method of claim 5 wherein said standard conditions being selected from the group consisting of temperature, humidity, light, and combinations thereof.

7. The method of claim 3 wherein spectrally measuring the submission further comprises generating a spectral measurement of the color of the submission, the spectral measurement being suitable for electronic comparison via color software.

8. The method of claim 4 wherein presenting the submission for spectrally measuring further comprises:
orienting the submission in a first position;
spectrally measuring the submission in the first position;
orienting the submission in a second position; and
spectrally measuring the submission in the second position.

9. The method of claim 8 further comprising:
repeating the spectral measurement of the submission in one of the positions a sufficient number of times to insure uniformity of the spectral measurement from the position.

10. The method of claim 2 further comprising:
calibrating the spectrophotometer coupled to the computer having the color identifying software prior to analyzing the submission.

11. The method of claim 10 wherein calibrating further comprises:
providing a standard reference having a known measurement;
measuring the standard reference in the spectrophotometer coupled to the computer having color identifying software;
comparing the measurement of the standard reference to the known measurement of the standard reference; and
adjusting, if necessary, the spectrophotometer coupled to the computer having color identifying software.

12. The method of claim 2 wherein analyzing further comprises:
spectromapping said spectrophotometer to a primary spectrophotometer.

13. The method of claim 12 wherein spectromapping further comprises defining an adjustment to said spectrophotometer so that spectral measurements of said spectrophotometer are equivalent to said primary spectrophotometer.

14. The method of claim 7 further comprising comparing the spectral measurement of the color of the submission to a spectral measurement of a specification provided by the retailer, and deciding based upon the comparison to accept/reject the submission.
